(19) United States
(12) Patent Application Publication
(10) Pub. No.: US 2007/0215578 A1
(43) Pub. Date: Sep. 20, 2007

(54) Apparatus for Melting Off Injection Needles

(75) Inventors: Sukenori Ito, Tokyo (JP); Masaaki Okuda, Matsubara-shi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignees: SOFTIC JAPAN CO., LTD., Tokyo (JP); SEIWA PRO CO., LTD., Matsubara-shi, Osaka (JP)

(21) Appl. No.: 11/568,316

(22) PCT Filed: Apr. 26, 2004
(86) PCT No.: PCT/JP04/06016

§ 371 Date: Oct. 26, 2006

(51) Int. Cl. B23H 1/00

(52) U.S. Cl. 219/68

(57) ABSTRACT

The invention relates to injection needle melt-off apparatuses that allow the life of the electrode rollers to be extended and processing costs to be reduced. An injection needle melt-off apparatus is made up of: a melt-off mechanism including two electrode rollers that can come into contact with the injection needle of a syringe, a rotational driving mechanism for rotating the electrode rollers, and a power application mechanism for applying electric power to the electrode rollers; a guide mechanism including a retaining member for holding the syringe and a guide member for engaging the retaining member and guiding the retaining member toward the electrode rollers so as to bring the injection needle of the syringe into contact with the electrode rollers; and a position adjustment mechanism for adjusting the relative positional relationship between the melt-off mechanism and the guide mechanism along the electrode-rollers axe so as to shift the position where the injection needle of the syringe comes into contact with the electrode rollers.

### TECHNICAL FIELD

The present invention relates to injection needle melt-off apparatuses for melting off, and discarding, the injection needles of used syringes.

### BACKGROUND ART

A used syringe may cause a secondary infection if the person handling the syringe inadvertently touches the injection needle, and this has led to recent proposals for injection needle melt-off apparatuses for melting and discarding injection needles. One example of such an injection needle melt-off apparatus that is known is disclosed in JP H11-285531A.

This injection needle melt-off apparatus is constituted from a melt-off mechanism for melting the injection needle of the syringe, and a guide mechanism that is disposed above this melt-off mechanism and that guides the injection needle toward the melt-off mechanism.

The melt-off mechanism is furnished with: a spaced-apart pair of electrode rollers that are disposed in parallel horizontally, for coming into contact with the injection needle of a syringe that has been guided between the rollers by the guide mechanism; a drive motor for rotating each electrode roller about its axis; and a power source for applying a voltage across the electrode rollers.

The guide mechanism is furnished with: a float guide designed in the form of a hollow cylinder with an open top and disposed with its longitudinal axis oriented vertically; a float inserted into and that can move up and down within the float guide; and a spring member disposed between the float guide and the float, one end of which abuts against the floor of the float guide and the other end of which abuts against the lower surface of the float.

A through-hole is furnished in the center part of the float-guide floor, penetrating the floor vertically, and the float guide is arranged so that the through hole is positioned above the electrode rollers.

In the center part of the float, a vertically penetrating retaining hole for holding the syringe is formed, coaxial with the through-hole in the float guide, wherein by means of the retaining hole the injection needle is retained in a vertical orientation, projecting downward from the underside of the float. Meanwhile, the float is biased upward by the spring member.

By means of this injection needle melt-off apparatus, with voltage applied across the electrode rollers and the electrode rollers rotated, an operator inserts a used syringe into the retaining hole in the float so it will hold the syringe, and then pushes the syringe downward together with the float against the biasing force of the spring member, whereby the syringe injection needle passes clear through the through-hole in the float guide and comes into contact with the electrode rollers, shorting them.

The closed circuit causes a large current to pass through the injection needle, whereby the injection needle emits heat and due to the emitted heat is dissolved, melts off, and drops down.

Afterwards, by the operator drawing up the syringe, the process is finished, and the float is raised together with the syringe, returning to its original position. The operator then repeats this procedure on other used syringes.

However, the electrode rollers' performance deteriorates with use, in that, among other reasons, owing to the electrical discharge between the electrode rollers and the injection needle, the area where the rollers come into contact with the injection needle is melt-damaged, leading to poor contact between the rollers and the injection needle, and the contact area becomes encrusted with the melted injection needle material, increasing its electrical resistance. Delivering stable current to the injection needle with electrode rollers whose performance has deteriorated proves difficult, making it harder to perform the above process reliably and thus prolonging the process time.

Consequently, it is necessary to change the electrode rollers when their performance has deteriorated (for example, when a set number of injection needles has been processed).

Nevertheless, in order to stably pass current into the injection needle, and to make the melt-damage to and encrustation on the electrode rollers less likely to occur, the rollers are composed of an expensive metallic substance of small electrical resistance, high melting point, and large thermal conductivity—such as titanium, tungsten, or an alloy of these with a material that includes copper or silver (such as brass or phosphor bronze)—and in order to bring the electrode rollers into association with electrical contacts for supplying current to the rollers and in order to increase their ability to radiate heat, the rollers are formed axially elongated, wherein—with the conventional injection needle melt-off apparatuses the configuration being such that the injection needles come into contact with the electrode rollers in the same position, limiting use to only that one area of the rollers—the consequent disadvantage is that process costs are elevated and the efficiency with which the electrode rollers are used is poor.

In addition, in situations in which the electrode rollers are changed frequently, then the effort involved in changing the electrode rollers leads to the problem that the injection-needle disposal process cannot be efficiently implemented.

An object of the present invention, brought about in light of the foregoing circumstances, is to make available an injection-needle melt-off apparatus that serves to prolong the life of the electrode rollers, enabling processing costs to be reduced.

### DISCLOSURE OF INVENTION

The present invention, which is for attaining the foregoing objectives, involves an injection needle melt-off apparatus, the apparatus being furnished with at least a melt-off mechanism for melting through the injection needle of a syringe, and a guide mechanism for guiding the injection needle toward the melt-off mechanism, wherein: the melt-off mechanism is furnished with a pair of electrode rollers disposed spaced apart in parallel, for coming into contact with an injection needle having been guided there by the guide mechanism, rotational driving means for rotating the electrode rollers about their center axes, and power application means for applying electric power to the electrode rollers; the guide mechanism is furnished with a retaining member for holding the syringe, and a guide member engaged with the retaining member to guide the retaining member toward the electrode rollers; and the injection needle melt-off apparatus is configured so that shifting of the retaining member guided by the guide member leads the syringe toward the electrode rollers, bringing the injection needle into contact with the electrode rollers. The injection needle melt-off apparatus is therein characterized in comprising a position adjustment mechanism for adjusting the relative positional relationship between the melt-off mechanism and the guide mechanism along the axes of the electrode rollers to shift the position where the injection needle of a syringe being held by the retaining member comes into contact with the electrode rollers.

According to this invention, the injection needle of a used syringe is melted and discarded as follows. That is, first the power application means applies a voltage between the electrode rollers and the rotational driving means rotates the electrode rollers about their axes.

Then, when the operator has the retaining member hold a used syringe and moves the syringe along the guide member via the retaining member, the syringe is lead toward the electrode rollers and the injection needle comes into contact with the electrode rollers.

As a result, the electrode rollers are shorted and a large current flows through the injection needle, heating and subsequently melting through the injection needle.

The operator then returns the syringe to its original position along with the retaining member and removes the syringe from the retaining member, ending the procedure.

The operator repeats this procedure for other used syringes, and when the area of the electrode rollers that comes into contact with the injection needles has deteriorated, that is, when it is determined that the number of injection needles that have been processed has reached a set number, the operator suitably manipulates the position adjustment mechanism to adjust the relative positional relationship between the melt-off mechanism and the guide mechanism in the axial direction of the electrode rollers, shifting the position where the injection needle of the syringe and the electrode rollers contact one another, and the operator continues the procedure.

Therefore, with the injection needle melt-off apparatus according to the invention, by suitably adjusting the contact position between the electrode rollers and the injection needle, the injection needle can be brought into contact with areas of the electrode rollers that have not yet been used, and a single electrode roller can continue to be used until all of the shifted contact positions have deteriorated, and thus, compared to the conventional injection needle melt-off apparatus described above in which it was not possible to change the position of contact between the injection needle and the electrode rollers, it is possible to more efficiently use the electrode rollers and thereby prolong their life, and processing costs can be reduced.

Extending the life of the electrode rollers obviates the need to frequently change them, and thereby eliminates the work associated with changing the electrode rollers and allows injection needles to be processed more efficiently.

It should be noted that it is also possible to adopt a configuration in which the position adjustment mechanism is made up of: a stand for supporting the guide member to allow it to travel paralleling the axes of the electrode rollers; a biasing means for biasing the guide member unilaterally along the roller axial orientation; and a position adjusting means for shifting the guide member axially against the biasing force of the biasing means, to adjust the axial position of the guide member shifting under the biasing force.

With this configuration as well, the contact position between the injection needle of the syringe and the electrode rollers can be shifted, due to the position adjusting means moving the guide member in the axial direction against the biasing force of the biasing means and adjusting the position of the guide member, which is moved by the biasing force, in the axial direction.

It is further possible to adopt a configuration in which the guide member the guide member is formed as a hollow cylinder open at both ends, and is installed with one of its open ends situated in opposition to the electrode rollers; the retaining member is fitted into the guide member to allow the retaining member to travel axially along the guide member; the biasing means is configured to abut, along the roller axial orientation, against one side of the guide member outer peripheral surface, biasing the guide member toward the side thereof opposite said one side; and the position adjusting means is made up of an abutting member disposed on the side of the guide member opposite from the biasing means and together with the biasing means flanking the guide member, for abutting, along the roller axial orientation, against the guide member outer peripheral surface on said opposite side, a support member supporting the abutting member to allow the abutting member to pivot within a plane parallel to the roller axial orientation, a switch lever for engaging with the abutting member and pivoting together with the abutting member, and a positioning member for positioning the switch lever in a plurality of positions along the course in which the switch lever pivots.

In this case as well, it is possible to adjust the position of the guide member in the axial direction to shift the contact position between the injection needle of the syringe and the electrode rollers because, if, by pivoting the switch lever to suitably change the position of the switch lever due to the positioning member, the switch lever is pivoted in the biasing direction of the biasing means, then the guide member can be moved toward the abutting member due to the biasing force of the biasing member, whereas if the switch lever is pivoted in the direction opposite the biasing direction of the biasing means, then the guide member can be moved toward the biasing means in opposition to the biasing force of the biasing means.

### BRIEF DESCRIPTION OF DRAWINGS

FIG. 1 is a cross-sectional view showing an overview of the structure of the injection needle melt-off apparatus according to an embodiment of the invention,

FIG. 2 is a cross-sectional view taken in the direction of the arrow A-A in FIG. 1, and

FIG. 3 is a cross-sectional view taken in the direction of the arrow B-B in FIG. 1.

FIG. 4 is a plan view in the direction of the arrow C in FIG. 1, and

FIG. 5 is a cross-sectional view in the direction of the arrow D-D in FIG. 2.

FIGS. 6 and 7 are cross-sectional views showing a state in which the float guide, etc., according to the embodiment have moved in a parallel fashion.

### BEST MODE FOR CARRYING OUT THE INVENTION

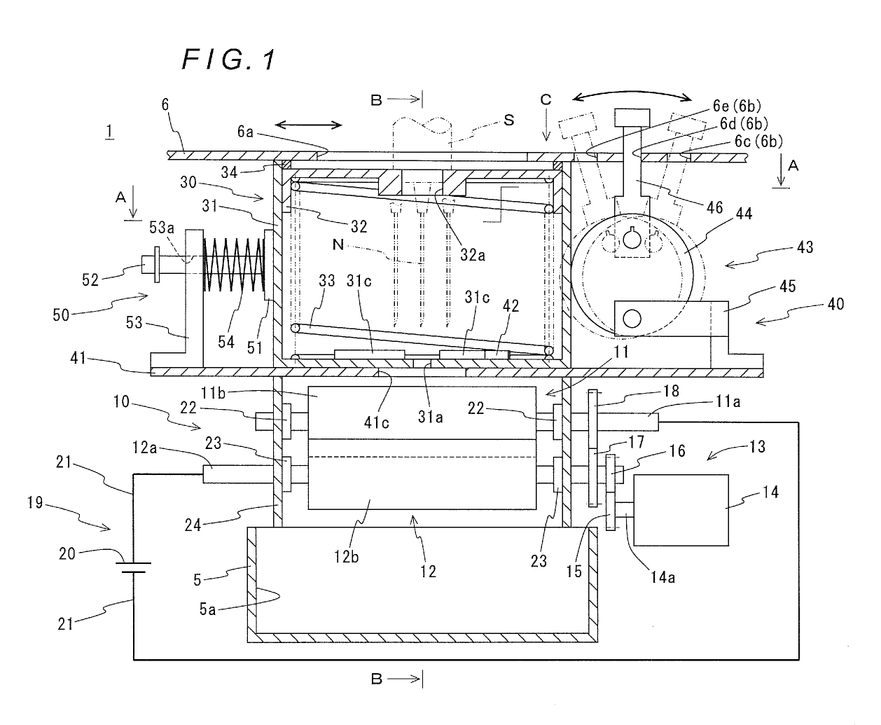

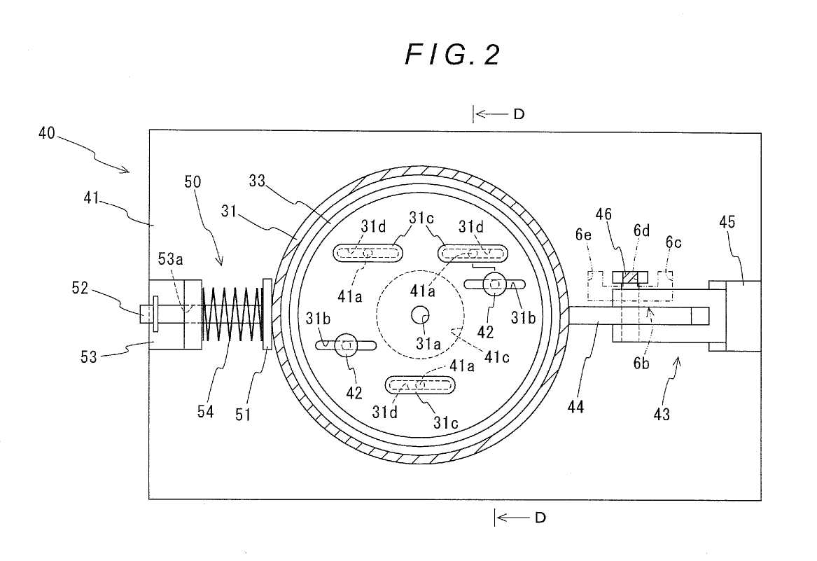

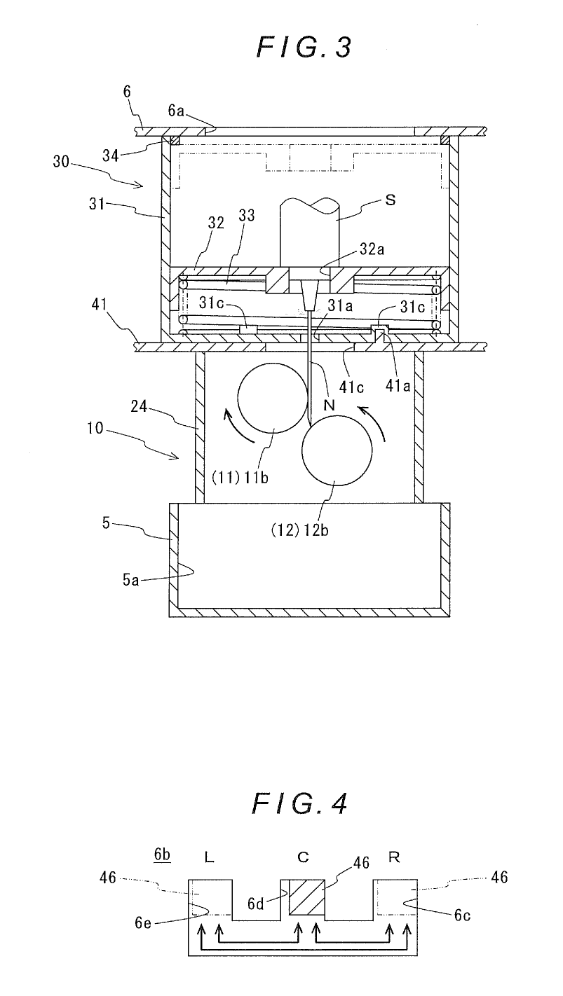

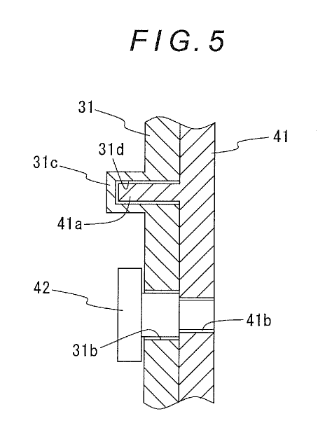

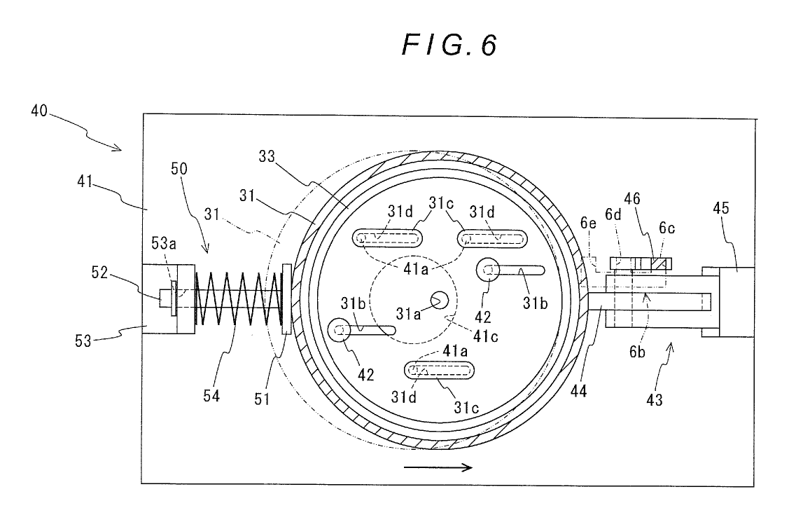

The present will now be described in more specific detail below in reference to the appended drawings. It should be noted that FIG. 1 is a cross-sectional view showing an overview of the structure of the injection needle melt-off apparatus according to an embodiment of the invention, FIG. 2 is a cross-sectional view taken in the direction of the arrow A-A in FIG. 1, and FIG. 3 is a cross-sectional view taken in the direction of the arrow B-B in FIG. 1. FIG. 4 is a plan view in the direction of the arrow C in FIG. 1, and FIG. 5 is a cross-sectional view in the direction of the arrow D-D in FIG. 2.

As shown in FIGS. 1 to 5, an injection needle melt-off apparatus 1 of this embodiment is provided with, among others, a melt-off mechanism 10 for melting an injection needle N of a syringe S, a guide mechanism 30 for guiding the injection needle N toward the melt-off mechanism 10, a position adjusting mechanism 40 for adjusting the relative positional relationship between the melt-off mechanism 10 and the guide mechanism 30, an injection needle recovery member 5 for recovering the injection needle N that has been melted by the melt-off mechanism 10, a frame (not shown) for supporting the melt-off mechanism 10, the guide mechanism 30, the position adjusting mechanism 40, and the injection needle recovery member 5, and a cover member 6 for covering the melt-off mechanism 10, the guide mechanism 30, the position adjusting mechanism 40, the injection needle recovery member 5, and the frame (not shown).

The melt-off mechanism 10 is furnished with, among others, a pair of electrode rollers (a first electrode roller 11 and a second electrode roller 12) that come into contact with the injection needle N of the syringe S that has been guided by the guide mechanism 30, a rotational driving mechanism 13 for rotating the electrode rollers 11 and 12 about their axes, and a power source 19 for applying a voltage between the electrode rollers 11 and 12 as well as for supplying power to the rotational driving mechanism 13.

The electrode rollers 11 and 12 are made of rotation shafts 11a and 12a that are disposed horizontally parallel to one another with a spacing between them, and main roller units 11b and 12b that fit on the rotation shafts 11a and 12a and that come into contact with the injection needle N of the syringe S. The main roller units 11b and 12b are made of a metal material such as titanium, tungsten, or an alloy of these with a material that includes copper or silver (such as brass or phosphor bronze), and the rotation shafts 11a and 12a are made of brass or phosphor bronze, for example.

The rotation shafts 11a and 12a of the electrode rollers 11 and 12 are supported by a support member 24 through bearings 22 and 23, the first electrode roller 11 is disposed at a higher position than the second electrode roller 12, and both end portions of the rotation shafts 11a and 12a extend outward from the support member 24. It should be noted that the support member 24 is suitably attached to the frame (not shown).

The rotational driving mechanism 13 is made of, among others, a drive motor 14 that is supported by a suitable support member that is not shown, a first gear 15 that is provided on an output shaft 14a of the drive motor 14, a second gear 16 and a third gear 17 that are provided on one end side of the rotation shaft 12a of the second electrode roller 12 with a predetermined spacing between them, and a fourth gear 18 that is provided on the first end side of the rotation shaft 11a of the first electrode roller 11, and the first gear 15 and the second gear 16 mesh with one another and the third gear 17 and the fourth gear 18 mesh with one another.

With the rotational driving mechanism 13, when the drive motor 14 is rotated, its rotational energy is transferred to the second electrode roller 12 through the first gear 15 and the second gear 16, causing the second electrode roller 12 to rotate about its axis. The rotational force of the second electrode roller 12 is transmitted to the first electrode roller 11 through the third gear 17 and the fourth gear 18, and causes the first electrode roller 11 to rotate about its axis. It should be noted that the electrode rollers 11 and 12 rotate in the arrow direction in different rotational directions.

The power source 19 is for example constituted by a battery 20 for applying a voltage to the electrode rollers 11 and 12 and for supplying power to the drive motor 14, a connection circuit 21 for connecting the battery 20 to the one end of the rotation shaft 11a of the first electrode roller 11 and for connecting the battery 20 to the other end of the rotation shaft 12a of the second electrode roller 12, and a circuit (not shown) that is for connecting the battery 20 and the drive motor 14.

Thus, with the melt-off mechanism 1 0, the drive motor 14 is driven by the power that is supplied from the battery 20 through a circuit (not shown) and rotates the electrode rollers 11 and 12 about their axes, and the battery 20 applies a voltage between the electrode rollers 11 and 12 via the connection circuit 21.

Then, when an injection needle N that has been guided by the guide mechanism 30 comes into contact with the electrode rollers 11 and 12 and shorts the electrode rollers 11 and 12, a large current flows to the injection needle N and heats up the injection needle N, melting through the injection needle N, and the injection needle N falls downward.

The guide mechanism 30 is furnished with a float guide 31 that is in the shape of an empty cylinder with an open upper portion and that is disposed with its axis oriented vertically, a float 32 that is inserted into and can move up and down within the float guide 31, a spring member 33 that is disposed between the float guide 31 and the float 32, one end of which abuts against the floor of the float guide 31 and the other end of which abuts against the lower surface of the float 32, and a stop 34 that is fitted into the open upper end of the float guide 31.

A through hole 31a that opens vertically is furnished in a central portion of the floor of the float guide 31, which is arranged in such a manner that the through hole 31a is positioned above the electrode rollers 11 and 12. In the floor of the float guide 31 are also formed two long holes 31b that are open vertically and that are long in the axial direction of the electrode rollers 11 and 12, and three projections 31c that project upwards and are in the axial direction of the electrode rollers 11 and 12, and recessions 31d are formed from the lower surface side of the float guide 31 toward the interior of the projections 31c.

It should be noted that the upper end surface of the float guide 31 abuts against the inner surface of the cover member 6, and the cover member 6 is provided with through holes 6a that pass from front-to-back and that are coaxial with the empty portion of the float guide 31.

The float 32 is provided in a central portion with a retaining hole 32a that is formed opening vertically and is coaxial with the through hole 31a of the float guide 31, and that is for holding the syringe S. Due to the retaining hole 32a, the syringe S is held in such a manner that its injection needle N is oriented vertically and points downward from the lower surface of the float 32. The float 32 is biased upward by the spring member 33 but is kept from moving upward by the stop 34.

Thus, with the guide mechanism 30, when an operator inserts a used syringe S into the retaining hole 32a of the float 32 from the through hole 6a of the cover member 6 to hold the syringe S, and then pushes the syringe S downward together with the float 32 against the urging force of the spring member 33, the injection needle N of the syringe S passes through the through hole 31a of the float guide 31 and arrives at, and comes into contact with, the electrode rollers 11 and 12.

On the other hand, when the operator pulls up the syringe S, the float 32 rises upward together with the syringe S due to the biasing force of the spring 33 and abuts against the stop 34.

The position adjusting mechanism 40 is furnished with a fixed bracket 41 that is provided on the upper surface of the support member 24 and that supports the lower surface of the float guide 31 in such a manner that it can move in the axial direction of the electrode rollers 11 and 12, a biasing mechanism 50 for biasing the float guide 31 to the one side in the axial direction, and a position adjusting mechanism 43 that moves the float guide 31 to the fixed bracket 41 against the biasing force applied by the biasing mechanism 50 so as to adjust the position of the float guide 31.

The fixed bracket 41 is a plate-shaped member that is fastened to the frame (not shown) and that has three columnar engaging projections 41a that stick out from its upper surface and engage the recessions 31d of the project guide 31, and two screw holes 41b that are open in the vertical direction and connected to the long holes 31b of the float guide 31, and a bolt 42 is screwed into each screw hole 41b from the float side of the float guide 31.

A connection hole 41c that is larger than the through hole 31a of the float guide 31 is formed vertically in the fixed bracket 41, and the connection hole 41c is in communication with the through hole 31a in each adjustment position of the float guide 31, which is adjusted by the position adjusting mechanism 43.

The biasing mechanism 50 is for example made from a plate-shaped abutting member 51 that abuts against the outer circumferential surface of the float guide 31 on one side in said axial direction, a columnar guide member 52 that is fastened to the abutting member 51, its longitudinal direction laying in said axial direction, a support member 53 that is provided erect on the fixed bracket 41 and that supports the guide member 52, and a spring member 54 that is disposed between the support member 53 and the abutting member 51, its ends in contact with opposing surfaces of the support member 53 and the abutting member 51.

The guide member 52 is passed through a support hole 53a that has been formed in the support member 53 and can move in said axial direction, and guides movement of the abutting member 51 in said axial direction. The abutting member 51, due to the biasing force of the spring member 54, biases the float guide 31 from the one side to the other side of its outer circumferential surface in said axial direction, that is, toward a cam 44, which is discussed below.

The position adjusting mechanism 43 is for example made of a disk-shaped cam 44 that is disposed at a position that is in opposition to the biasing mechanism 50, sandwiching the float guide 31 between them, and that abuts against the outer circumferential surface of the float guide 31 on its other side in said axial direction, a support member 45 for supporting the cam 44 that is arranged on the fixed bracket 41, and a switch lever 46 that engages the cam 44.

The lower outer circumferential side of the cam 44 is supported by the support member 45 in such a manner that the cam 44 can swing within a vertical plane that is parallel to said axial direction. The switch lever 46 can engage the upper outer circumferential side of the cam 44 and pivot together with the cam 44, and is designed such that it engages an engagement groove 6b that has been formed in the front-to-back direction of the cover member 6.

The engagement groove 6b is provided with three engagement portions 6c, 6d, and 6e in said axial direction, and the switch lever 46 is positioned by engaging the engagement groove 6b at three positions in its pivot direction (R (engagement portion 6c), C (engagement portion 6d), and L (engagement portion 6e)). It should be noted that the cover member 6 also functions as the positioning member discussed in the claims.

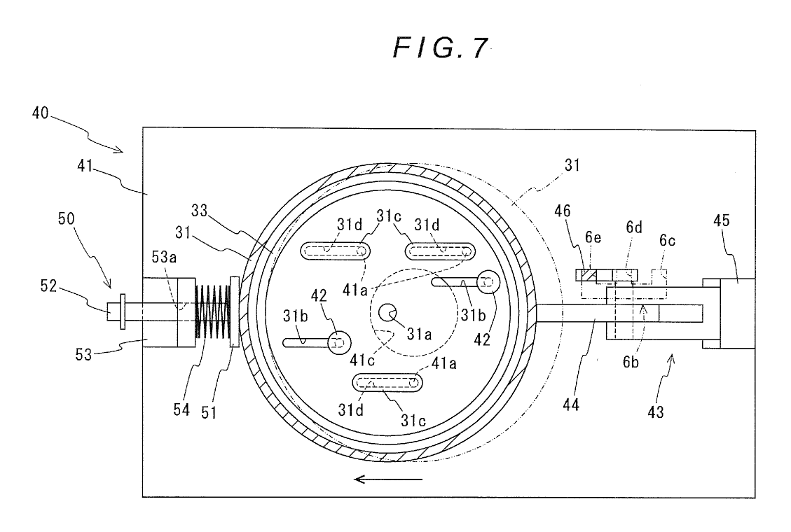

Thus, with the position adjusting mechanism 40, when the switch lever 46 is pivoted from a position at the engagement portion 6d in the center of the engagement groove 6b by bending it perpendicular to the pivot plane and positioned at the engagement portion 6c on the right (in the other side direction of the outer circumferential surface of the float guide 31), the cam 44 is pivoted together with the switch lever 46 in the other side direction about a support provided by the support member 45, and thus, as shown in FIG. 6, the float guide 31 is moved in the other side direction (toward the cam 44) due to the biasing force of the spring member 54 via the abutting member 51.

On the other hand, when the switch lever 46 is pivoted from a position at the engagement portion 6d in the center by bending it perpendicular to the pivot plane and positioned at the engagement portion 6e on the left (in the one side direction of the outer circumferential surface of the float guide 31), the cam 44 is pivoted together with the switch lever 46 in the one side direction about a support provided by the support member 45, and thus, as shown in FIG. 7, the float guide 31 is moved in the one side direction (toward the abutting member 51) against the biasing force of the spring member 54 via the abutting member 51.

Similarly, when the switch lever 46 is pivoted from a position at the engagement portion 6c on the right side of the engagement groove 6b to a position at the engagement portion 6d in the center or the engagement portion 6e on the left, the float guide 31 is moved toward the abutting member 51, and when the switch lever 46 is pivoted from a position at the engagement portion 6e on the left side of the engagement groove 6b to a position at the engagement portion 6d in the center or the engagement portion 6c on the right, the float guide 31 is moved toward the cam 44.

By switching the position of the switch lever 46 in this way, the float guide 31 can be moved toward the cam 44 or the abutting member 51, thereby moving the injection needle N of the syringe S that is held by the float 32 in the axial direction of the electrode rollers 11 and 12 so as to shift the position where the injection needle N comes into contact with the electrode rollers 11 and 12 (adjust between three positions).

It should be noted that movement of the float guide 31 is guided by the recessions 31d and the engaging projections 41a, and the bolts 42 keep the float guide 31 from rising upward.

The injection needle recovery member 5 is provided below the support member 24 of the melt-off mechanism 10 and is formed empty with an open top, and the injection needle N that has been melted in two by the electrode rollers 11 and 12 falls into an empty portion 5a of the injection needle recovery member 5.

With the injection needle melt-off apparatus 1 of this embodiment having the above structure, first the electrical power that is supplied from the power source 19 drives the drive motor 14, and a voltage is applied between the electrode rollers 11 and 12 by the power source 19 as they are rotated about their axes.

Next, an operator inserts a used syringe S into the retaining hole 32a of the float 32 to hold the syringe S, and when he lowers the syringe S against the biasing force of the spring member 33, the injection needle N of the syringe S is passed through the through hole 31a of the float guide 31 and the connection hole 41c of the fixed bracket 41, arriving at and coming into contact with the electrode rollers 11 and 12.

Thus, when the electrode rollers 11 and 12 are shorted and a large current flows to the injection needle N, the injection needle N is heated and is melted in two, and the melted injection needle N falls downward (into the injection needle recovery member 5).

As the operator then pushes the syringe S further downward, the injection needle N is sequentially melted from its lower side to its upper side, melting substantially the entire injection needle N.

Then, when the operator pulls up the syringe S, it rises up together with the float 32 and is returned to its original position. The procedure of melting and disposing of the injection needle N of the syringe S is then ended by pulling out the syringe S from the float 32.

The operator then repeats this procedure for other used syringes S, and when the sections of the electrode rollers 11 and 12 that come into contact with the injection needle N have deteriorated, that is, when it has been determined that a set number of injection needles N have been processed, the position adjusting mechanism 40 is suitably operated to shift the position where the injection needle N of the syringe S comes into contact with the electrode rollers 11 and 12 in the axial direction of the electrode rollers 11 and 12, and then processing is continued.

Specifically, the switch lever 46 is operated to switch the position where it engages the engagement portions 6c, 6d, and 6e of the engagement groove 6b, and by pivoting the switch lever 46 together with the cam 44, the float guide 31 is moved in the axial direction of the electrode rollers 11 and 12, and as a result, the injection needle N of the syringe S that is held by the float 32 is moved in the axial direction, shifting the position where the injection needle N and the electrode rollers 11 and 12 come into contact.

Thus, with the injection needle melt-off apparatus of this embodiment, the injection needle N can be brought into contact with unused portions of the electrode rollers 11 and 12 by suitably shifting the position where the injection needle N and the electrode rollers 11 and 12 come into contact, and it is possible to continue using a single pair of electrode rollers 11 and 12 until all of the various contact positions that may be shifted to are used up, and thus compared to the conventional injection needle melt-off apparatus discussed above, in which it was not possible change the contact position between the injection needle and the electrode rollers, the electrode rollers 11 and 12 can be used more efficiently and their life extended, and this allows processing costs to be reduced.

Since the life of the electrode rollers 11 and 12 is extended, it is no longer necessary to frequently change these, and thus the task of processing injection needles N can be carried out more efficiently because the work involved with changing the electrode rollers 11 and 12 is obviated.

The present invention was described in one embodiment above, but the specific forms that the invention may take are in no way limited to this.

In the above example, the position of the float guide 31 (the injection needle N of the syringe S) is adjusted between three positions, but it is for example also possible to adopt a configuration in which it is adjusted between five positions, and there are no particular limitations regarding the number of positions that it may be adjusted between.

Further, in the configuration of the above example, the float guide 31 is moved to the electrode rollers 11 and 12 by the position adjustment mechanism 40, but this is not a limitation, and it is also possible to adopt a configuration in which the electrode rollers 11 and 12 are moved to the float guide 31.

### INDUSTRIAL APPLICABILITY

As illustrated above, the injection needle melt-off apparatus of the invention can be favorably used when melting and discarding the injection needles of used syringes.

1. An apparatus for melting off injection needles, the apparatus furnished with at least a melt-off mechanism for melting through the injection needle of a syringe, and a guide mechanism for guiding the injection needle toward the melt-off mechanism, wherein
the melt-off mechanism is furnished with a pair of electrode rollers disposed spaced apart in parallel, for coming into contact with an injection needle having been guided there by the guide mechanism, rotational driving means for rotating the electrode rollers about their center axes, and power application means for applying electric power to the electrode rollers;
the guide mechanism is furnished with a retaining member for holding the syringe, and a guide member engaged with the retaining member to guide the retaining member toward the electrode rollers; and
the injection needle melt-off apparatus is configured so that shifting of the retaining member guided by the guide member leads the syringe toward the electrode rollers, bringing the injection needle into contact with the electrode rollers; the injection needle melt-off apparatus characterized in comprising:
a position adjustment mechanism for adjusting the relative positional relationship between the melt-off mechanism and the guide mechanism along the axes of the electrode rollers to shift the position where the injection needle of a syringe being held by the retaining member comes into contact with the electrode rollers.

2. The injection needle melt-off apparatus according to claim 1, characterized in that the position adjustment mechanism is made up of: a stand for supporting the guide member to allow it to travel paralleling the axes of the electrode rollers; a biasing means for biasing the guide member unilaterally along the roller axial orientation; and a position adjusting means for shifting the guide member axially against the biasing force of the biasing means, to adjust the axial position of the guide member shifting under the biasing force.

3. The injection needle melt-off apparatus according to claim 2, characterized in that:
the guide member is formed as a hollow cylinder open at both ends, and is installed with one of its open ends situated in opposition to the electrode rollers;
the retaining member is fitted into the guide member to allow the retaining member to travel axially along the guide member;
the biasing means is configured to abut, along the roller axial orientation, against one side of the guide member outer peripheral surface, biasing the guide member toward the side thereof opposite said one side; and
the position adjusting means is made up of
an abutting member disposed on the side of the guide member opposite from the biasing means and together with the biasing means flanking the guide member, for abutting, along the roller axial orientation, against the guide member outer peripheral surface on said opposite side,
a support member supporting the abutting member to allow the abutting member to pivot within a plane parallel to the roller axial orientation,
a switch lever for engaging with the abutting member and pivoting together with the abutting member, and
a positioning member for positioning the switch lever in a plurality of positions along the course in which the switch lever pivots.
